(19) United States
(12) Patent Application Publication
(10) Pub. No.: US 2014/0255680 A1
(43) Pub. Date: Sep. 11, 2014

(54) ENVIRONMENTAL BARRIER COATING-BASED THERMAL BARRIER COATINGS FOR CERAMIC MATRIX COMPOSITES

(71) Applicant: Rolls-Royce Corporation, Indianapolis, IN (US)

(72) Inventors: Kang N. Lee, Zionsville, IN (US); Jay Lane, Mooresville, IN (US)

(21) Appl. No.: 14/193,419

(22) Filed: Feb. 28, 2014

Related U.S. Application Data
(60) Provisional application No. 61/776,353, filed on Mar. 11, 2013.

(51) Int. Cl. C09D 1/02

(52) U.S. Cl. CPC C09D 1/02
USPC 428/312.6

(57) ABSTRACT

A thermal barrier coating composition for a ceramic matrix composite is provided. The thermal barrier coating comprises a porous layer and a doped rare earth disilicate layer. The porous layer is located over the doped rare earth disilicate layer. The porous layer includes a fugitive material.

### RELATED APPLICATIONS

This application is related to and claims priority to U.S. Provisional Patent Application Ser. No. 61/776,353, filed on Mar. 11, 2013 entitled “Environmental Barier Coating-Based Thermal Barrier Coatings for Ceramic Matrix Composites.” The subject matter disclosed in that provisional application is hereby expressly incorporated into the present application in its entirety.

### TECHNICAL FIELD AND SUMMARY

The present disclosure relates to thermal barrier coatings for ceramic matrix composites, and in particular, dense/porous dual microstructure environmental barrier coatings used in high-temperature mechanical systems such as gas turbine engines.

A gas turbine engine, such as an aircraft engine, operates in severe environments. Ceramic matrix composite (CMC) components have excellent high temperature mechanical, physical, and chemical properties which allow gas turbine engines to operate at much higher temperatures than current engines with superalloy components. An issue with CMC components, however, is their lack of environmental durability in combustion environments. Water vapor, a combustion reaction product, reacts with protective silica scale on silicon carbide/silicon carbide (SiC/SiC), CMCs, or alumina matrix in oxide/oxide CMCs, forming gaseous reaction products such as Si(OH)₄ and Al(OH)₃, respectively. In high pressure, high gas velocity gas turbine environments, this reaction may result in surface recession of the CMC.

The present disclosure relates to thermal barrier coatings (TBCs) for ceramic matrix composites (CMCs) based on dense/porous dual microstructure environmental barrier coatings (EBCs). An embodiment of the present disclosure includes a combination of a doped rare earth disilicate bond coat and a porous rare earth silicate or barium-strontium-aluminosilicate (BSAS) top coat to create a low thermal conductivity, long life EBC for CMC applications.

Another illustrative embodiment of the present disclosure provides a thermal barrier coating composition for a ceramic matrix composite. The thermal barrier coating comprises a porous barium-strontium-aluminosilicate layer and a doped rare earth disilicate layer. The porous barium-strontium-aluminosilicate layer is located over the doped rare earth disilicate layer. The doped rare earth disilicate layer is located between the porous barium-strontium-aluminosilicate layer and the ceramic matrix composite. The porous barium-strontium-aluminosilicate layer includes a fugitive material selected from the group consisting of at least one of graphite, hexagonal boron nitride, and a polymer. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance of the doped rare earth disilicate layer being the disilicate.

In the above and other illustrative embodiments, the thermal barrier coating composition may further comprise: the dopant being the Al₂O₃ which is present in an amount between about 0.5 wt % and about 3 wt %; the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; the doped rare earth disilicate layer having a thickness of between about 0.5 mils to about 10 mils: and the doped rare earth disilicate layer having a thickness of between about 1 mil to about 3 mils.

Another illustrative embodiment of the present disclosure provides a thermal barrier coating composition for a ceramic matrix composite comprising a porous barium-strontium-aluminosilicate layer, a doped rare earth disilicate layer, and a silicon coat layer. The porous barium-strontium-aluminosilicate layer is located over the doped rare earth disilicate layer. The doped rare earth disilicate layer is located between the porous barium-strontium-aluminosilicate layer and the silicon coat layer. The silicon coat layer is located between the doped rare earth disilicate layer and the ceramic matrix composite. The porous barium-strontium-aluminosilicate layer includes a fugitive material. The fugitive material is selected from the group consisting of at least one of graphite, hexagonal boron nitride, and a polymer. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance of the doped rare earth disilicate layer being the disilicate.

In the above and other illustrative embodiments, the thermal barrier coating composition may further comprise: the dopant being the Al₂O₃ which is present in an amount between about 0.5 wt % and about 3 wt %: the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; the doped rare earth disilicate layer having a thickness of between about 0.5 mils to about 10 mils: the doped rare earth disilicate layer having a thickness of between about 1 mil to about 3 mils.

Another illustrative embodiment of the present disclosure provides a thermal barrier coating composition for a ceramic matrix composite comprising: a porous rare earth disilicate layer, and a doped rare earth disilicate layer. The porous rare earth disilicate layer is located over the doped rare earth disilicate layer. The doped rare earth disilicate layer is located between the porous rare earth disilicate layer and the ceramic matrix composite. The porous rare earth disilicate layer includes a fugitive material that is selected from the group consisting of at least one of graphite, hexagonal boron nitride, and a polymer. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance of the doped rare earth disilicate layer being the disilicate; the dopant being the Al₂O₃ which is present in an amount between about 0.5 wt % and about 3 wt %; the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; the doped rare earth disilicate layer having a thickness of between about 0.5 mils to about 10 mils; the doped rare earth disilicate layer having a thickness of between about 1 mil to about 3 mils.

Another illustrative embodiment of the present disclosure provides a thermal barrier coating composition for a ceramic matrix composite comprising a porous rare earth disilicate layer, a doped rare earth disilicate layer, and a silicon coat layer. The porous rare earth disilicate layer is located over the doped rare earth disilicate layer. The doped rare earth disilicate layer is located over the silicon coat layer. The silicon coat layer is located between the doped rare earth disilicate layer and the ceramic matrix composite. The porous rare earth disilicate layer includes a fugitive material selected from the group consisting of at least one of graphite, hexagonal boron nitride, and a polymer. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance of the doped rare earth disilicate layer being the disilicate.

In the above and other illustrative embodiments, the thermal barrier coating composition may further comprise: the dopant being the Al₂O₃ which is present in an amount between about 0.5 wt % and about 3 wt %; the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; the doped rare earth disilicate layer has a thickness of between about 0.5 mils to about 10 mils; the doped rare earth disilicate layer has a thickness of between about 1 mil to about 3 mils.

Another illustrative embodiment of the present disclosure provides a thermal barrier coating composition for a ceramic matrix composite comprising: a mixture of porous rare earth disilicate and monosilicate layer, and a doped rare earth disilicate layer. The mixture of porous rare earth disilicate and monosilicate layer is located over the doped rare earth disilicate layer. The doped rare earth disilicate layer is located between the mixture of porous rare earth disilicate and rare earth monosilicate layer and the ceramic matrix composite. The mixture of porous rare earth disilicate and monosilicate layer includes a fugitive material selected from the group consisting of at least one of graphite, hexagonal boron nitride, and a polymer. The disilicate of the porous rare earth disilicate and monosilicate layer has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The monosilicate of the porous rare earth disilicate and monosilicate layer has a composition of RE₂SiO₅, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant Is present in an amount between about 0.1 wt % and about 5 wt %, and the balance of the doped rare earth disilicate layer being the disilicate.

In the above and other illustrative embodiments, the thermal barrier coating composition may further comprise: the dopant being the Al₂O₃ which is present in an amount between about 0.5 wt % and about 3 wt %; the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; the doped rare earth disilicate layer having a thickness of between about 0.5 mils to about 10 mils; and the doped rare earth disilicate layer having a thickness of between about 1 mil to about 3 mils.

Another illustrative embodiment of the present disclosure provides a thermal barrier coating composition for a ceramic matrix composite comprising; a mixture of porous rare earth disilicate and monosilicate layer, a doped rare earth disilicate layer, and a silicon coat layer. The mixture of porous rare earth disilicate and monosilicate layer is located over the doped rare earth disilicate layer. The doped rare earth disilicate layer is located over the silicon coat layer. The silicon coat layer is located between the doped rare earth disilicate layer and the ceramic matrix composite. The mixture of porous rare earth disilicate and monosilicate layer includes a fugitive material selected from the group consisting of at least one of graphite, hexagonal boron nitride, and a polymer. The disilicate of the mixture of rare earth disilicate and monosilicate layer has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The monosilicate of the mixture of rare earth disilicate and monosilicate layer has a composition of RE₂SiO₅, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance of the doped rare earth disilicate layer is the disilicate.

In the above and other illustrative embodiments, the thermal barrier coating composition may further comprise: the dopant being the Al₂O₃ which is present in an amount between about 0.5 wt % and about 3 wt %; the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; the doped rare earth disilicate layer having a thickness of between about 0.5 mils to about 10 mils; and the doped rare earth disilicate layer having a thickness of between about 1 mil to about 3 mils.

Additional features and advantages of the thermal barrier coatings will become apparent to those skilled in the art upon consideration of the following detailed description of the illustrated embodiments exemplifying the best mode of carrying out the disclosure as presently perceived.

### BRIEF DESCRIPTION OF DRAWINGS

The present disclosure will be described hereafter with reference to the attached drawings which are given as non-limiting examples only, in which:

FIG. 1 is a cross-sectional diagram of a ceramic matrix composite material coated with a porous barium-strontium-aluminosilicate layer, and a doped rare earth disilicate layer;

FIG. 2 is a cross-sectional diagram of a ceramic matrix composite material coated with a porous barium-strotium-alumiosilicate layer, a doped rare earth disilicate layer and a silicon bond coat layer;

FIG. 3 is a cross-sectional diagram of a ceramic matrix composite coated with a porous rare earth disilicate layer, and a doped rare earth disilicate layer;

FIG. 4 is a cross-sectional diagram of a ceramic matrix composite coated with a porous rare earth disilicate layer, a doped rare earth disilicate layer, and a silicon bond coat layer;

FIG. 5 is a cross-sectional diagram of a ceramic matrix composite material coated with a porous rare earth monosilicate layer, a porous rare earth disilicate layer, and a doped rare earth disilicate layer;

FIG. 6 is a cross-sectional diagram of a ceramic matrix composite material coated with a porous rare earth monosilicate layer, a porous rare earth disilicate layer, a doped rare earth disilicate layer, and a silicon bond coat layer;

FIG. 7 is a cross-sectional diagram of a ceramic matrix composite material coated with a mixture of porous rare earth monosilicate and porous rare earth disilicate layer, and a doped rare earth disilicate layer: and

FIG. 8 is a cross-sectional diagram of a ceramic matrix composite material coated with a mixture of porous rare earth monosilicate and porous rare earth disilicate layer, a doped rare earth disilicate layer, and a silicon bond coat layer.

Corresponding reference characters indicate corresponding parts throughout the several views. The exemplification set out herein illustrates embodiments of the thermal barrier coatings and such exemplification is not to be construed as limiting the scope of the thermal barrier coatings in any manner.

### DETAILED DESCRIPTION

The present disclosure is directed to TBCs for CMCs. An illustrative embodiment includes a TBC based on dense/porous dual microstructure environmental barrier coatings (EBCs).

This EBC-based TBC utilizes a doped rare earth disilicate bond coat for long steam cycling life and a porous EBC for low thermal conductivity. Illustratively, the EBC includes at least one of the rare earth silicates (i.e., RE₂Si₂O₇ wherein RE=at least one of lutetium, ytterbium, thulium, erbium, holmium, dysprosium, terbium, gadolinium, europium, sambarium, promethium, neodymium, praseodymium, cerium, lanthanum, yttrium, and scandium) and is doped with at least one of A₂O₃, alkali oxides, and alkali earth oxides. Porous EBC is selected from rare earth silicates (RE₂Si₂O or RE₂SiO₅) wherein RE=at least one of lutetium, ytterbium, thulium, erbium, holmium, dysprosium, terbium, gadolinium, europium, sambarium, promethium, neodymium, praseodymium, cerium, lanthanum, yttrium, and scandium) or barium-strontium-aluminosilicate (BSAS: 1-xBaO.xSrO.Al₂O₃.2SiO₂ where 0≦x≧1). A porous microstructure is created by adding a fugitive material in the EBC. The fugitive material may burn off in a subsequent exposure to a high temperature, either via heat treatment or during service leaving a porous EBC microstructure. The fugitive material comprises at least one of graphite, hexagonal boron nitride, and polymer. The fugitive material may be incorporated in the EBC by spraying a mixture of EBC and fugitive powder, co-spraying EBC and fugitive powder, or spraying a pre-alloyed, EBC plus fugitive powder.

The rare earth silicate is doped with at least one of Al₂O₄, alkali oxides, and alkali earth oxides in direct contact with the CMC. This may improve the oxidation life of the EBC-coated, CMC system by providing strong chemical bonding with the CMC. Porous BSAS or rare earth silicate EBC applied over the EBC provides thermal insulation due to the low thermal conductivity. The low thermal conductivity of porous EBC is attributed to photon scattering at the pores. In an illustrative embodiment, a silicon bond coat may be applied between the dense doped rare earth disilicate and the CMC substrate to further improve the EBC-CMC bonding.

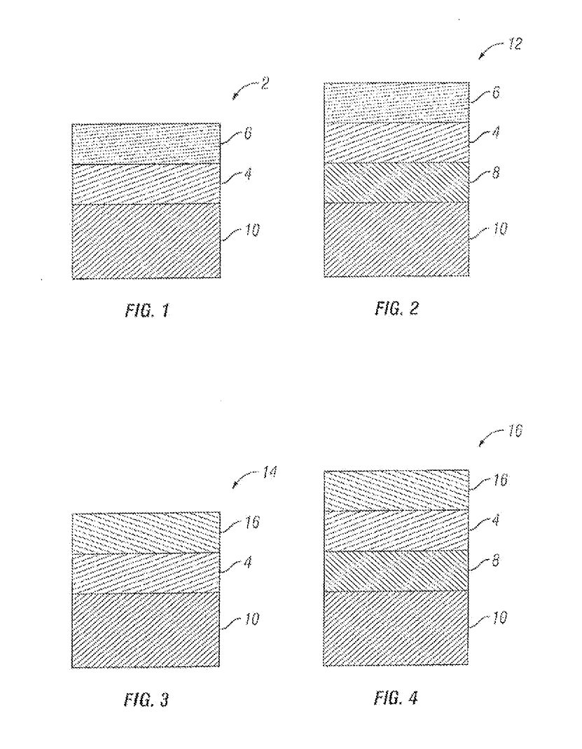

An illustrative embodiment, as shown in FIG. 1, includes an environmental barrier coat-based thermal barrier coat 2 that incorporates a dense doped rare earth silicate layer 4 located between porous BSAS layer 6 and CMC Layer 10. In an embodiment, the rare earth element may be ytterbium (Yb). It is appreciated, however, that the other previously-described rare earth elements may also be used.

The porous BSAS layer includes a fugitive material that may be selected from the group consisting of at least one of graphite, hexagonal boron nitrite, and a polymer. The doped rare earth disilicate layer may include a disilicate having a composition of RE₂Si₂O₇ wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The dopant is selected from the group consisting of at least one of an Al₂O₃, alkali oxide and alkali earth oxide. The dopant is present in an amount between about 0.1 wt % and about 5 wt % with the balance being the disilicate.

The doped rare earth silicate bond coat improves the thermal cycling life of EBC compared to undoped rare earth silicate bond coat by at least a factor of about four. The thermal conductivity of a rare earth silicate EBC with 40% porosity is about 0.5-0.6 w/m-K, which is similar to the lower limit of low thermal conductivity zirconia or hafnia-based TBCs for superalloys. The coefficient of thermal expansion (CTE) of low thermal conductivity zirconia or hafnia-based TBCs is more than twice the CTE of CMC, causing high residual stresses and short thermal cycling life when applied on CMCs. In contrast CTE's of BSAS and rare earth silicates are similar to that of CMCs. The doped rare earth silcate/porous EBC combines a long thermal cycling life and a very low thermal conductivity for CMC applications.

Plasma spraying is used to fabricate the coating. Illustratively, the CMC substrate may include one of the following: a Si-containing ceramic, such as silicon carbide (SiC), silicon nitride (Si₃N₄), a CMC having a SiC or Si₃N₄ matrix, silicon oxynitride, and silicon aluminum oxynitride; a Si-containing metal alloy, such as molybdenum-silicon alloys (e.g. MoSI₂) and niobium-silicon alloys (e.g. NbSi₂); and an oxide-oxide CMC. The CMCs may comprise a matrix reinforced with ceramic fibers, whiskers, platelets, and chopped or continuous fibers.

It is appreciated that when the dopant is Al₂O₃, it may be present in an amount between about 0.5 wt % and about 3 wt %, or about 0.5 wt % to about 1 wt %. In contrast, when the dopant is the alkali oxide, it may be present in an amount between about 0.1 wt % and about 1 wt %. Similarly, when the dopant is an alkali earth oxide, it is present in an amount between about 0.1 wt % and about 1 wt %. It is appreciated that the doped rare earth disilicate layer 4 may have a thickness of between about 0.5 mils to about 10 mils, or about 1 mil to about 3 mils.

Another illustrative embodiment of the present disclosure, as shown in FIG. 2, includes an environmental barrier coat-based thermal barrier coat 12 that includes a doped rare earth disilicate layer disilicate layer 4 located between porous BSAS layer 6 and silicon bond coat 8. Likewise, silicon bond coat 8 is located between doped rare earth disilicate layer 4 and CMC layer 10. Like the prior barrier coating 2, barrier coating 10 includes fugitive material in the porous BSAS layer 6. The fugitive material is selected from the group consisting of at least one graphite, hexagonal boron nitride, and a polymer. Also like coat 2, the doped rare earth disilicate layer includes a disilicate having a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. A dopant for layer 4 may also include at least one of Al₂O₃, alkali oxide, and alkali earth oxide. The dopant is present in an amount between about 0.1 wt % and about 5 wt % with the balance of the layer being disilicate. Like prior embodiments, when the dopant is Al₂O₃, it is present in an amount between about 0.5 wt % and about 3 wt %, or in an amount between about 0.5 wt % and about 1 wt %. When the dopant is alkali oxide, it may be present in an amount between about 0.1 wt % and about 1 wt %. If the dopant is an alkali earth oxide, it may be present in an amount between about 0.1 wt % and about 1 wt %. The doped rare earth disilicate layer 4 may have a thickness of between about 0.5 mils to about 10 mils, or about 1 mil to about 3 mils.

Another illustrative embodiment of the present disclosure is shown in FIGS. 3 and 4 which include an environmental barrier coat-based thermal barrier coat 14 which includes a porous rare earth disilicate layer 16 top coat over a doped rare earth disilicate layer 4 located over CMC layer 10. In this embodiment porous rare earth disilicate layer 16 includes a fugitive material selected from the group consisting of at least one graphite, hexagonal boron nitride, and a polymer. Doped rare earth disilicate layer 4, similar to prior embodiments, has a composition of RE₂Si₂O₇ wherein RE selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. Also the doped rare earth disilicate layer includes dopant selected from the group consisting of at least one of an Al₂O₃, alkali oxide, and alkali earth oxide. The dopant is present in an amount between about 0.1 wt % and about 5 wt % with the balance being the disilicate. It is appreciated that in the coating 14, like coating 12 previously described, it may have the dopants in the same weight percentages. Doped rare earth disilicate layer 4 may also have a thickness between about 0.5 mils and about 10 mils, or about 1 mil to about 3 mils.

The thermal barrier coat 16, shown in FIG. 4 is similar to that shown in FIG. 3 except a silcon bond coat layer 8 is located between doped disilicate layer 4 and CMC layer 10. It is appreciated that the characteristics of these layers are similar to that previously described.

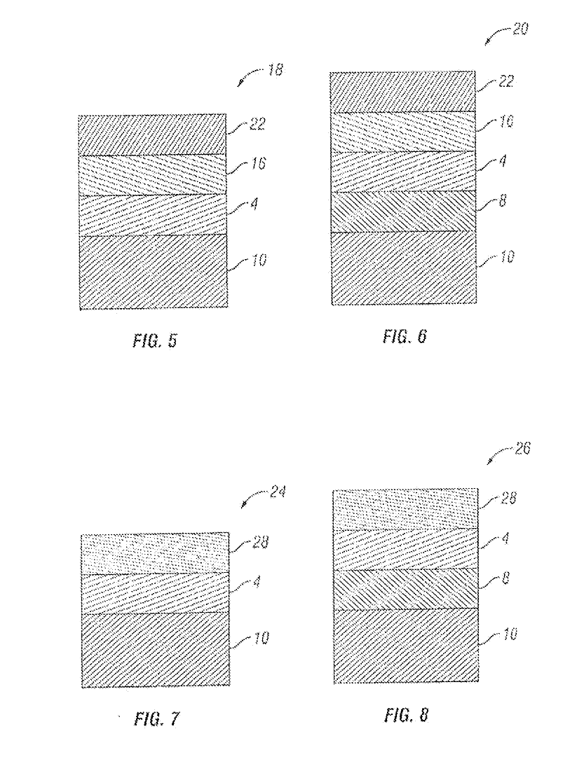

Other illustrative embodiments, as shown in FIGS. 5 and 6, include environmental barrier coat-based thermal barrier coats 18 and 20, respectively. Coat 18 is similar to that shown in FIG. 3 with porous rare earth disilicate layer 16 over doped rare earth disilicate layer 4, which is located over CMC layer 10. This embodiment, however, includes a porous rare earth monosilicate layer 22. This monosilicate layer 22 includes a fugitive material that is selected from the group consisting of at least one graphite, hexagonal boron nitride, and a polymer. The monosilicate has a composition of RE₂SiO₅ wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. It is appreciated that the porous rare earth monosilicate layer 22 is the top coat layer. Thermal barrier coat 20 is similar to coat 18, previously discussed, except a silicon bond coat layer 8 is located between the dense doped rare earth disilicate layer 4 and CMC layer 10.

Another illustrative embodiment of the present disclosure, as shown in FIGS. 7 and 8, includes environmental barrier coat-based thermal barrier coats 24 and 26, respectively. The embodiments shown in FIG. 4, for example, include a doped rare earth disilicate layer 4 located between a mixture of porous rare earth disilicate and rare earth monosilicate layer 28 and CMC layer 10. The mixture of porous rare earth disilicate and rare earth monosilicate layer 28 includes a fugitive material similar to that discussed in prior embodiments. The fugitive material is selected from the group consisting of at least one graphite, hexagonal boron nitride, and a polymer. The disilicate of the porous rare earth disilicate and monosilicate layer 28 has a composition of RE₂Si₂O₇ wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. Likewise, the monosilicate of the porous rare earth disilicate and monosilicate layer 28 has a composition of RE₂SiO₅ wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. Doped rare earth disilicate layer 4 includes the same disilicate composition RE₂Si₂O₇, and contains the same rare earth elements, as previously discussed. Likewise, the dopant of layer 4 may include Al₂O₃, alkali oxide, and alkali earth oxide where the dopant is present in an amount between about 0.1 wt % and about 5 wt % with the balance being the disilicate. The dopants may also have the particular amounts, as discussed, with respect to layer 4 in the other embodiments. Environmental barrier coat-based thermal barrier coat 26 is similar to that described with respect to coat 24 except a silicon bond coat layer 8 is located between doped rare earth disilicate layer 4 and CMC layer 10. Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims. Further, the terms doped and dopant as used herein applies a conventional meaning wherein a composition forms a homogeneous chemistry and crystal structure.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A thermal barrier coating composition for a ceramic matrix composite comprising:
a porous barium-strontium-aluminosilicate layer;
a doped rare earth disilicate layer;
wherein the porous barium-strontium-aluminosilicate layer is located over the doped rare earth disilicate layer;
wherein the doped rare earth disilicate layer is located between the porous barium-strontium-aluminosilicate layer and the ceramic matrix composite;
wherein the porous barium-strontium-aluminosilicate layer includes a fugitive material;
wherein the fugitive material is selected from the group consisting of at least one of graphite, hexagonal boron nitride, and a polymer;
wherein the doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium;
wherein the doped rare earth disilicate layer includes a dopant that is Al₂O₃ and alkali oxide; and
wherein the dopant is present in an amount between about 0.1 wt % and about 5 wt %, and the balance of the doped rare earth disilicate layer being the disilicate.

2. The thermal barrier coating composition of claim 1, wherein the Al₂O₃ is present in an amount between about 0.5 wt % and about 3 wt %.

3. The thermal barrier coating composition of claim 1, wherein the Al₂O₃ is present in an amount between about 0.5 wt % and about 1 wt %.

4. The thermal barrier coating composition of claim 1, wherein the alkali oxide is present in an amount between about 0.1 wt % and about 1 wt %.

5. The thermal barrier coating composition of claim 1, wherein the doped rare earth disilicate layer has a thickness of between about 0.5 mils to about 10 mils.

6. The thermal barrier coating composition of claim 1, wherein the doped rare earth disilicate layer has a thickness of between about 1 mil to about 3 mils.

7. A thermal barrier coating composition for a ceramic matrix composite comprising:
a porous rare earth disilicate layer;
a doped rare earth disilicate layer;
wherein the porous rare earth disilicate layer is located over the doped rare earth disilicate layer;
wherein the doped rare earth disilicate layer is located between the porous rare earth disilicate layer and the ceramic matrix composite;
wherein the porous rare earth disilicate layer includes a fugitive material;
wherein the fugitive material is selected from the group consisting of at least one of graphite, hexagonal boron nitride, and a polymer;
wherein the doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium;
wherein the doped rare earth disilicate layer includes a dopant that is Al₂O₃ and alkali oxide; and
wherein the dopant is present in an amount between about 0.1 wt % and about 5 wt %, and the balance of the doped rare earth disilicate layer being the disilicate.

8. The thermal barrier coating composition of claim 7, wherein the Al₂O₃ is present in an amount between about 0.5 wt % and about 3 wt %.

9. The thermal barrier coating composition of claim 7, wherein the Al₂O₃ is present in an amount between about 0.5 wt % and about 1 wt %.

10. The thermal barrier coating composition of claim 7, wherein the alkali oxide is present in an amount between about 0.1 wt % and about 1 wt %.

11. The thermal barrier coating composition of claim 7, further comprising a porous rare earth monosilicate layer; wherein the porous rare earth monosilicate layer includes a fugitive material; wherein the fugitive material is selected from the group consisting of at least one of graphite, hexagonal boron nitride, and a polymer; the monosilicate has a composition of RE₂SiO₅, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium; and wherein the porous rare earth monosilicate layer is located over the porous rare earth disilicate layer.

12. The thermal barrier coating composition of claim 7, wherein the doped rare earth disilicate layer has a thickness of between about 0.5 mils to about 10 mils.

13. The thermal barrier coating composition of claim 7, wherein the doped rare earth disilicate layer has a thickness of between about 1 mil to about 3 mils.

14. A thermal barrier coating composition for a ceramic matrix composite comprising:
a porous rare earth disilicate layer;
a doped rare earth disilicate layer;
a silicon coat layer;
wherein the porous rare earth disilicate layer is located over the doped rare earth disilicate layer;
wherein the doped rare earth disilicate layer is located over the silicon coat layer;
wherein the silicon coat layer is located between the doped rare earth disilicate layer and the ceramic matrix composite;
wherein the porous rare earth disilicate layer includes a fugitive material;
wherein the fugitive material is selected from the group consisting of at least one of graphite, hexagonal boron nitride, and a polymer;
wherein the doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium;
wherein the doped rare earth disilicate layer includes a dopant that is Al₂O₃, and alkali oxide; and
wherein the dopant is present in an amount between about 0.1 wt % and about 5 wt %, and the balance of the doped rare earth disilicate layer being the disilicate.

15. The thermal barrier coating composition of claim 14, wherein the Al₂O₃ is present in an amount between about 0.5 wt % and about 3 wt %.

16. The thermal barrier coating composition of claim 14, wherein the Al₂O₃ is present in an amount between about 0.5 wt % and about 1 wt %.

17. The thermal barrier coating composition of claim 14, wherein the alkali oxide is present in an amount between about 0.1 wt % and about 1 wt %.

18. The thermal barrier coating composition of claim 14, further comprising a porous rare earth monosilicate layer; wherein the porous rare earth monosilicate layer includes a fugitive material; wherein the fugitive material is selected from the group consisting of at least one of graphite, hexagonal boron nitride, and a polymer: the monosilicate has a composition of RE₂SiO₅, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium; and wherein the porous rare earth monosilicate layer is located over the porous rare earth disilicate layer; and
wherein the doped rare earth disilicate layer has a thickness of between about 0.5 mils to about 10 mils.
